(19) United States
(12) Patent Application Publication
(10) Pub. No.: US 2023/0400916 A1
(43) Pub. Date: Dec. 14, 2023

(54) GLASSES WITH MOUSE FUNCTION AND WORDING METHOD OF SAME

(71) Applicant: Zhenkun Wang, Marblehead, MA (US)

(72) Inventor: Zhenkun Wang, Marblehead, MA (US)

(21) Appl. No.: 18/097,943

(22) Filed: Jan. 17, 2023

(30) Foreign Application Priority Data
Jun. 8, 2022 (CN) 202221438765.X

(51) Int. Cl. G06F 3/01; G06F 3/02

(52) U.S. Cl. CPC G06F 3/013; G06F 3/0227

(57) ABSTRACT

Glasses with a mouse function include eyeball-capturing signal emitting devices, eyeball-capturing signal receiving devices, an eyeball-movement capturing glasses instrument, and mouse function realizing foot pedals. The present invention is convenient in use, and can trigger the mouse to move through eyeball movement. Furthermore, the foot pedals can replace the functions of the buttons of a mouse, thereby releasing two hands, alleviating diseases caused by a mouse, so that the operation of the computer enters a new field.

### CROSS REFERENCE TO RELATED APPLICATION

This application claims the benefits of Chinese application Serial No. 202221438765.X, filed on Jun. 8, 2022, the disclosures of which are incorporated by references herein in its entirety.

### TECHNICAL FIELD

The present invention relates to the field of mouse technology, and more particularly to glasses with a mouse function and a working method thereof.

### BACKGROUND

Computers have become an essential part of everyday office and household equipment. Many people cannot work without computers, and use mouses for a long time every day; At the same time, it is difficult for some disabled people to use the mouse as an input device to control and use the computer, which reduces the opportunities for them to work and study. The existing conventional mouse needs to be manipulated with a human's right or left hand, thereby clicking, double-clicking, scrolling and so on to the computer. In recent years, the diseases caused by using the mouse have become more and more serious and common, such as wrist syndrome, mouse hands, etc., and the above problems have not been well resolved. If the function of the mouse can be replaced by the cooperation of eyes and feet, it will not only alleviate various symptoms caused by the mouse and expand the scope of computer users, such as disabled people, but also greatly promote the technological innovation of computer operating equipment.

### SUMMARY

An object of the present invention is to provide glasses with a mouse function, controlling a mouse position through eyeball movement, and controlling mouse button functions through foot pedals, so as to achieve releasing both hands, increase office efficiency, and improve user experience.

To achieve the above object, the present invention provides the following technical solutions:
glasses with a mouse function includes eyeball-capturing signal emitting devices, eyeball-capturing signal receiving devices, an eyeball-movement capturing glasses instrument, and mouse-function realizing foot pedals, the transmission mode of an output control unit thereof is a cable structure USB interface or Bluetooth wireless transmission.
The eyeball-capturing signal emitting devices are adapted to send out signals like radar waves continuously to eyes, and sense the position of the eyeball;
the eyeball-capturing signal receiving devices are adapted to receive continuously the signals like radar waves reflected from the eyeball position to obtain an eyeball movement position, and transmit it to the eyeball-movement capturing glasses instrument;
a chip in the eyeball-movement capturing glasses instrument locates the position where eyes gaze, and transmits the signal to the computer through a cable or Bluetooth transmission, thereby controlling the mouse position on the computer;
the left, middle and right buttons represented by the foot pedals are respectively adapted to replace the left, middle and right buttons of a mouse, and in connection with the computer through Bluetooth;
after the mouse is not moved for a certain period of time, the cursor automatically returns to a certain fixed position on the computer screen, where the fixed position and the time during the mouse is not moved both can be set, for example, set to that the mouse automatically returns to the lower right of the computer after 5 minutes of no movement, which is convenient for a user to find the mouse quickly after the computer is not used for a long time.

### BRIEF DESCRIPTION OF THE DRAWINGS

FIG. 1 is a schematic view of glasses with a mouse function of a preferred embodiment of the present invention;

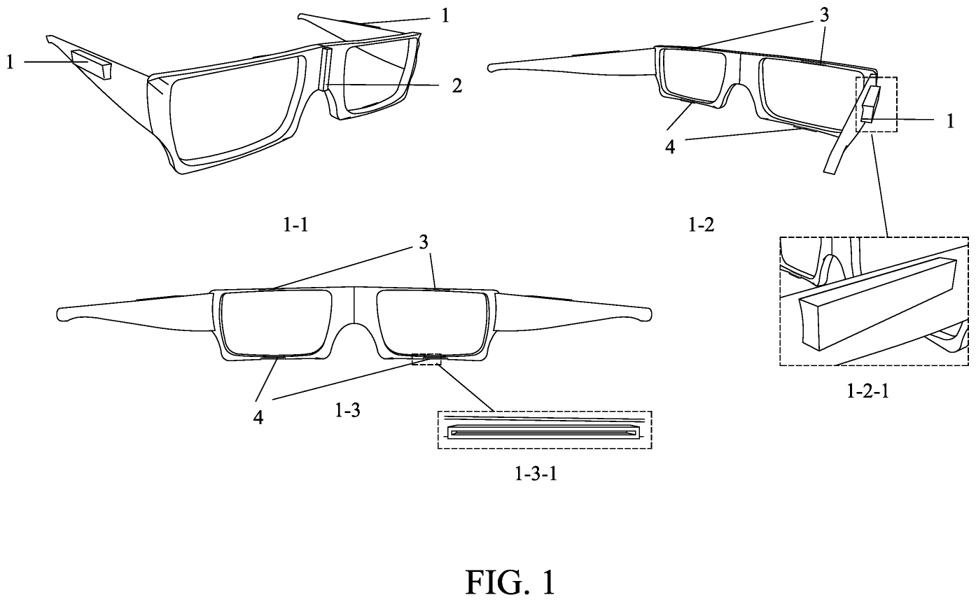

FIG. 2 is a schematic view of the working principle of the glasses with a mouse function of the embodiment of the present invention; and

FIG. 3 is a schematic view of foot pedals for use with the glasses with a mouse function of the embodiment of the present invention,

where the reference numbers in the accompanying drawings are: 1: battery of glasses with a mouse function; 2: chip of glasses with a mouse function; 3: eyeball-capturing signal emitting device; 4: eyeball-capturing signal receiving device; 5: Bluetooth wireless signal receiver of glasses with a mouse function; 6: glasses.

### DETAILED DESCRIPTION

The following embodiments will further describe glasses with a mouse function and a working method thereof according to the present invention in detail in conjunction with the accompanying drawings. Apparently, the described embodiments are only a part of the embodiments of the present invention, not all of them. Based on the embodiments of the present invention, all other embodiments obtained by persons of ordinary skill in the art without making creative efforts belong to the protection scope of the present invention.

In a preferred embodiment, glasses with a mouse function of the present invention includes eyeball-capturing signal emitting devices, eyeball-capturing signal receiving devices, an eyeball-movement capturing glasses instrument, and foot pedals for realizing the mouse function.

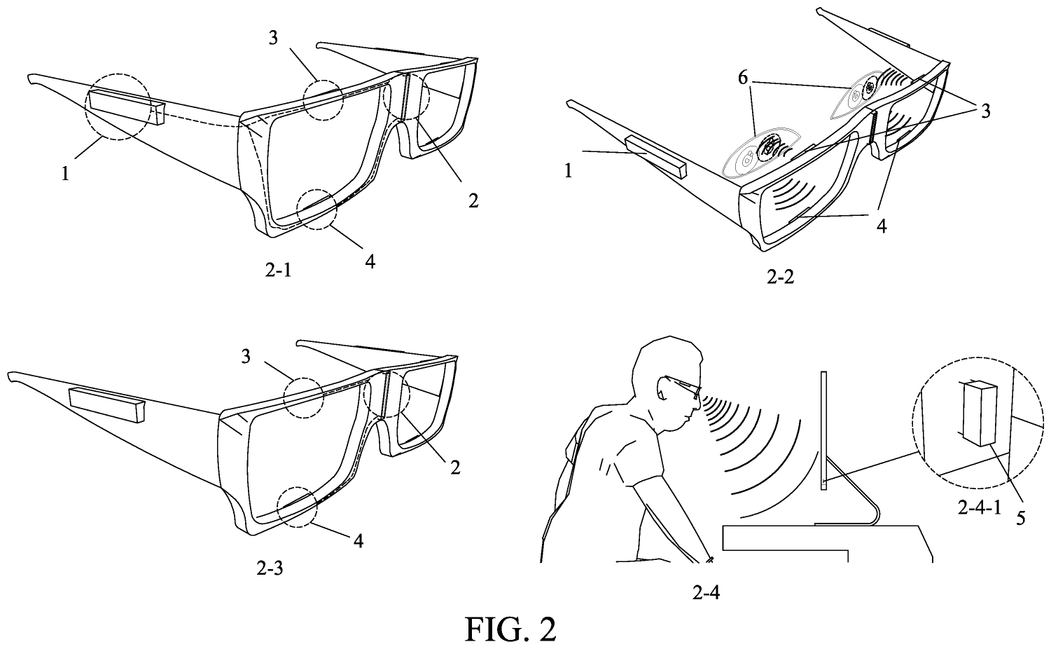

Referring to FIG. 2, the eyeball-capturing signal emitting device 3 of a glasses mouse sends out signals like radar waves continuously to the eyeball to sense the position of the eyeball.

The eyeball-capturing signal receiving device 4 is adapted to receive the signals like radar waves continuously to obtain an eyeball movement position and transmit it to the eyeball-movement capturing glasses instrument.

A chip 2 in the eyeball-movement capturing instrument locates the position where the eyes gaze, and transmits the signals to a computer through a cable or Bluetooth wireless signal receiver 5, thereby controlling the mouse position on the computer.

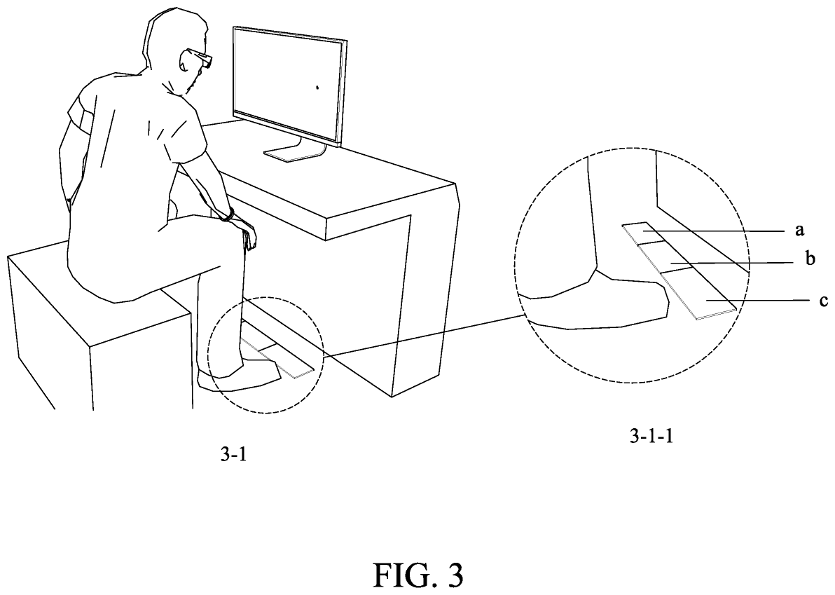

Referring to FIG. 3, a left button a, middle button b and right button c represented by the matching pedals are respectively used to replace the left, middle and right buttons of a mouse.

After the mouse is not moved for a certain period of time, the cursor automatically returns to a certain fixed position on the computer screen, where the fixed position and the time during the mouse is not moved both can be set, for example, set to that the mouse automatically returns to the lower right of the computer after 5 minutes of no movement, which is convenient for a user to find the mouse quickly after the computer is not used for a long time.

The specific embodiments described herein are intended to be illustrative of the invention only. Those skilled in the art to which the present invention pertains may make various modifications or supplements to the described specific embodiments or replace them in similar ways without departing from the protection scope of the present invention.

What is claimed is:

1. Glasses with a mouse function, comprising:
eyeball-capturing signal emitting devices, adapted to send out signals like radar waves to eyes, and sense the movement direction of the eyeball;
eyeball capturing signal receiving devices, adapted to receive sensed eyeball movement direction signals;
an eyeball-movement capturing glasses instrument, adapted to convert said captured eyeball movement direction to an electrical signal, and transmit said signal onto a computer through a cable or Bluetooth wireless transmission, realizing the movement of a mouse curser; and
mouse function realizing foot pedals, adapted to replace mouse buttons, said three pedals respectively replacing left, middle and right buttons of a mouse.

2. The glasses according to claim 1, wherein the transmission mode of an output control unit of said glasses with a mouse function is a cable structure USB interface or Bluetooth wireless transmission.

3. The glasses according to claim 1, wherein the transmission mode of an output control unit of said pedal is a cable structure USB interface or Bluetooth wireless transmission.

4. The glasses according to claim 1, wherein a battery compartment is located in the temples on either side of said glasses.

5. The glasses according to claim 1, wherein after said mouse is not moved for a certain period of time, a cursor automatically returns to a fixed position on said computer screen, and both said fixed position and said time during said mouse is not moved can be set, which is convenient for a user to quickly find said mouse when said computer is not used for a long time.

6. A working method of the glasses with a mouse function according to claim 1, comprising:
sending out signals like radar waves continuously to eyes through said eyeball-capturing signal emitting device to sense the position of said eyeball;
receiving said signals like radar waves reflected from said eyeball position through said eyeball-capturing signal receiving device to obtain the position of eyeball movement, and transmitting said signals to said eyeball-movement capturing glasses instrument;
calculating and positioning a position where eyes gaze through a chip in said eyeball-movement capturing glasses instrument, and transmitting said position to said computer through a cable or Bluetooth wireless transmission, thereby controlling said mouse position on said computer; and
replacing left, middle and right buttons of a mouse with said left, middle and right buttons represented by said foot pedals.

7. A working method of the glasses with a mouse function according to claim 2, comprising:
sending out signals like radar waves continuously to eyes through said eyeball-capturing signal emitting device to sense the position of said eyeball;
receiving said signals like radar waves reflected from said eyeball position through said eyeball-capturing signal receiving device to obtain the position of eyeball movement, and transmitting said signals to said eyeball-movement capturing glasses instrument;
calculating and positioning a position where eyes gaze through a chip in said eyeball-movement capturing glasses instrument, and transmitting said position to said computer through a cable or Bluetooth wireless transmission, thereby controlling said mouse position on said computer; and
replacing left, middle and right buttons of a mouse with said left, middle and right buttons represented by said foot pedals.

8. A working method of the glasses with a mouse function according to claim 3, comprising:
sending out signals like radar waves continuously to eyes through said eyeball-capturing signal emitting device to sense the position of said eyeball;
receiving said signals like radar waves reflected from said eyeball position through said eyeball-capturing signal receiving device to obtain the position of eyeball movement, and transmitting said signals to said eyeball-movement capturing glasses instrument;
calculating and positioning a position where eyes gaze through a chip in said eyeball-movement capturing glasses instrument, and transmitting said position to said computer through a cable or Bluetooth wireless transmission, thereby controlling said mouse position on said computer; and
replacing left, middle and right buttons of a mouse with said left, middle and right buttons represented by said foot pedals.

9. A working method of the glasses with a mouse function according to claim 4, comprising:
sending out signals like radar waves continuously to eyes through said eyeball-capturing signal emitting device to sense the position of said eyeball;
receiving said signals like radar waves reflected from said eyeball position through said eyeball-capturing signal receiving device to obtain the position of eyeball movement, and transmitting said signals to said eyeball-movement capturing glasses instrument;
calculating and positioning a position where eyes gaze through a chip in said eyeball-movement capturing glasses instrument, and transmitting said position to said computer through a cable or Bluetooth wireless transmission, thereby controlling said mouse position on said computer; and
replacing left, middle and right buttons of a mouse with said left, middle and right buttons represented by said foot pedals.
